(19) United States
(12) Patent Application Publication
(10) Pub. No.: US 2017/0305731 A1
(43) Pub. Date: Oct. 26, 2017

(54) PRESSURIZED TEMPERATURE-CONTROLLED LIQUID INFUSING DEVICE

(71) Applicant: FUSION TOWER, LLC, Yardley, PA (US)

(72) Inventor: Mathew J. KYLE, Yardley, PA (US)

(21) Appl. No.: 15/517,936

(22) PCT Filed: Jun. 29, 2015
(86) PCT No.: PCT/US15/38319

§ 371 Date: Apr. 7, 2017

Related U.S. Application Data
(60) Provisional application No. 62/069,560, filed on Oct. 28, 2014.

(51) Int. Cl. B67D 1/00; B67D 1/08; C12C 5/02; C12G 3/07

(52) U.S. Cl. CPC B67D 1/0009; C12C 5/026; B67D 1/08; C12G 3/065

(57) ABSTRACT

An invention for infusing liquids, such as beer or wine, at a desired temperature and pressure is disclosed. The invention comprises a fillable container to contain the infusing material and the liquid to be infused, a cooling system to maintain the temperature of the liquid at a desired level during infusion, and a pressurization system to facilitate dispensing the liquid after infusion.

The present application is based on and claims the benefit of U.S. provisional patent application Ser. No. 62/069,560, filed Oct. 28, 2014, the content of which is hereby incorporated by reference in its entirety.

### FIELD OF INVENTION

The present invention generally relates to infusing a liquid at a pre-determined temperature in a pressurize container.

### BACKGROUND OF THE INVENTION

Beverage infusers, such as those intended for tea, have been in use for thousands of years. Infusing flavors into beer pre and post fermentation has also been common practice for many beer brewers. However, very little has been developed in terms of infusing flavors into beer after the beer has been put into kegs or bottles. Early pioneers of post-packaged beer infusing used a variety of methods to infuse flavors into the beer such as coffee presses, pool filters, and tea infusers. However, all of these methods had two significant issues. First, these methods had no practical way of keeping the beer cold during the infusion process. When beer rises above 38° F., dissolved carbon dioxide in the beer will exit and cause foaming. Secondly, those methods did not have ideal pressure control. When beer leaves the keg at a relatively high pressure and enters a space of relatively low-pressure, dissolved carbon dioxide will exit the solution and cause foaming as a result of the pressure drop. Keeping the beer cold can mitigate this foaming, but it is the harmonic combination of pressure and temperature that creates a functional beer infuser.

Recent inventions, such as the “Fusion Tower” (Kyle PCT/U.S. 13/65429) and Dogfish Head's “Randall,” have attempted to solve the temperature issue by rapidly cooling the beer after it has been infused. However, rapidly cooling the beer after it has been infused is not ideal because there is still carbonation loss during the actual infusion process. Other products, such as the Blichmann “Hop Rocket,” attempted to solve this issue by putting the entire infuser in a refrigerated space, but that approach deprived the consumer (beer drinker) of the ability to see the infusion process, which has tremendous market value. The Hop

Rocket also presented issues with user friendliness because whenever it (or a similarly operating device) needed to be emptied, filled, or refreshed with new ingredients, the user had to leave the bar to tend to the infuser, which is often far away in the keg refrigerator room. Additionally, all three of these previously mentioned inventions required extensive retrofitting to properly integrate into an existing draft beer system. Retrofitting and extensive installation requirements present a large obstacle that is inhibiting large-scale market adoption of any beer infuser.

Other designs have also had issues with not being able to completely dispense the contents of the infuser into a glass for service, which can waste some of the product being infused.

Thus, there is a need for a simpler infusion device that can overcome these problems.

### SUMMARY OF THE INVENTION

The present invention relates to a system for infusing liquids, comprising a fillable container with an interior chamber adapted to contain an infusing material and a liquid, the fillable container pressurized when containing a liquid therein; a liquid outlet in fluid communication with the interior chamber; a gas inlet in fluid communication with the interior of the fillable container; and a controller in operative association with the liquid outlet and gas inlet so that as liquid is dispensed from the liquid outlet, the gas valve opens to introduce gas into the chamber to maintain pressure therein.

This system further includes a source of pressurized gas operatively associated with the gas inlet, with the controller allowing pressurized gas to pass through the gas valve into the container as infused liquid is dispensed to maintain pressure therein. Additionally, the system advantageously includes a gas outlet or gas valve for the fillable container and a gas pressure sensor in the fillable container, wherein the gas pressure sensor is operatively associated with the gas outlet or gas valve to allow release of gas when a desired pressure is exceeded.

As the infused liquid to be dispensed is preferably a cooled beverage, the system typically includes a heat exchanger in thermal contact with the interior of the fillable container; and a cooling system in thermal contact with the heat exchanger to control the temperature of the liquid as it is being infused. Thus, the fillable container is configured and dimensioned to be sufficiently close to the heat exchanger to provide effectively cooling of the liquid in the container. This can be achieved by accommodating ice formation on the heat exchanger while allowing the liquid to flow nearby.

In a preferred embodiment, the heat exchanger is operatively associated with a cooling system that includes refrigerant to form a closed-loop cooling system wherein the heat exchanger allows expansion of the refrigerant to provide cooling. The system may include a temperature sensor located in the liquid in a lower portion of the fillable container wherein the sensor is operatively associated with the cooling system to cause the cooling system to provide refrigerant when temperatures fall below a certain value are measured.

For filling the container and dispensing the infused liquid, the system further comprises a source of liquid, a first flow conduit that directed the liquid to the fillable container, a valve located on the flow conduit that when open allows liquid from the source to pass through the valve and conduit and into the fillable container. For versatility, the system includes a junction downstream of the valve which includes a second flow conduit that is operatively associated with the liquid outlet to allow dispensing of infused liquid through the liquid outlet when the valve is closed or dispensing of non-infused liquid through the liquid outlet when the valve is open.

In another preferred embodiment, the system further comprises a cage for containing infusible material, the cage configured and dimensions to reside within the fillable container and located in a position such that the liquid in the container contacts the infusible material in the cage prior to being dispensed through the liquid outlet. Depending upon the type of infusible material, the system may include a filter element located upstream of the liquid outlet to remove particulate material from the infused liquid.

The system also may include lighting elements associated with the fillable container as described herein to impart various visual effects to the container or to liquid contained therein. If desired, the system can further comprise an auxiliary device that provides movement of the liquid or the infusible material in the fillable container to promote contact infusing of the infusible material into the liquid.

Another embodiment of the invention is a system for infusing liquids, comprising a fillable container with an interior adapted to contain an infusing material and a liquid; a liquid valve in fluid communication with the interior of the fillable container; a liquid inlet in fluid communication with the liquid valve; a liquid outlet in fluid communication with the liquid valve; a gas inlet in fluid communication with the interior of the fillable container; a gas outlet in fluid communication with the interior of the fillable container; and a gas valve in fluid communication with the gas inlet.

This embodiment typically includes the heat exchanger in thermal contact with the interior of the fillable container; and a cooling system in thermal contact with the heat exchanger to control the temperature of the liquid as it is being infused. And as above, the gas outlet is a pressure relief valve and a gas pressure sensor is connected to the interior of the fillable container, wherein the gas pressure sensor is coupled to the gas valve. Also, a temperature sensor can be connected to the interior of the fillable container, wherein the temperature sensor is coupled to the cooling system.

A preferred cooling system is comprised of one of a thermoelectric cooling system, a canister adapted to hold a cooling medium, and vapor compression cycle refrigeration system. The system can include various filters, including a liquid filter between the liquid valve and the interior of the fillable container as well as a gas filter connected to the gas inlet. The gas filter is preferably a sintered filter. The system can include a gas switch coupled to the gas valve and a liquid switch coupled to the liquid valve. The system further comprises a source of a pressurized gas connected to the gas valve, wherein the pressurized gas is comprised of one of carbon dioxide, nitrogen, and air.

The system comprises one or more faucets in fluid communication with the liquid outlet, the liquid inlet or combinations thereof for dispensing of an infused liquid or the liquid coming from the source. One or more lighting components can be mounted on the system and directed to provide light into the liquid or fillable container. A first faucet in fluid communication with the liquid outlet can be electrically coupled to the light, a temperature sensor coupled to the cooling system can be electrically coupled to the light, or the liquid valve is electrically coupled to the light, so that dispensing of the infused liquid or a change in temperature can be observed with a change in the lighting of the fillable container or liquid.

Another embodiment is a system for infusing liquids, comprising a fillable container with an interior adapted to contain an infusing material and a liquid; a liquid inlet in fluid communication with the interior of the fillable container; a first liquid valve in fluid communication with the liquid inlet; a liquid outlet in fluid communication with the interior of the fillable container; a second liquid valve in fluid communication with the liquid outlet; a gas inlet in fluid communication with the interior of the fillable container; a gas outlet in fluid communication with the interior of the fillable container; and a gas valve in fluid communication with the gas inlet.

In addition to the features of the other embodiments, this system can further include a first liquid switch coupled to the first liquid valve, a second liquid switch coupled to the second liquid valve or a liquid switch coupled to both the first and second liquid valves.

Yet another embodiment is a complete system for infusing liquids, comprising a fillable container with an interior adapted to contain an infusing material and a liquid; a liquid valve in fluid communication with the interior of the fillable container; a liquid inlet in fluid communication with the liquid valve; a liquid outlet in fluid communication with the liquid valve; a liquid switch coupled to the liquid valve; a liquid filter between the liquid valve and the interior of the fillable container; a handle coupled to the liquid outlet; a gas inlet in fluid communication with the interior of the fillable container; a gas outlet in fluid communication with the interior of the fillable container; a gas valve in fluid communication with the gas inlet; a gas switch coupled to the gas valve; a gas pressure sensor connected to the interior of the fillable container; a heat exchanger in the center of the fillable container and in thermal contact with the interior of the fillable container; a vapor compression cycle refrigeration system in thermal contact with the heat exchanger to control the temperature of the liquid as it is being infused; and a temperature sensor connected to the interior of the fillable container, wherein the temperature sensor is coupled to the vapor compression cycle refrigeration system.

Another complete system for infusing liquids, comprises a fillable container with an interior adapted to contain an infusing material and a liquid; a liquid inlet in fluid communication with the interior of the fillable container; a first liquid valve in fluid communication with the liquid inlet; a liquid outlet in fluid communication with the interior of the fillable container; a second liquid valve in fluid communication with the liquid outlet; a liquid filter between the second liquid valve and the interior of the fillable container; a liquid switch coupled to the first liquid valve; a gas inlet in fluid communication with the interior of the fillable container; a gas outlet in fluid communication with the interior of the fillable container; a gas valve in fluid communication with the gas inlet; a gas switch coupled to the gas valve; a gas pressure sensor connected to the interior of the fillable container; a heat exchanger in the center of the fillable container and in thermal contact with the interior of the fillable container; a vapor compression cycle refrigeration system in thermal contact with the heat exchanger to control the temperature of the liquid as it is being infused; and a temperature sensor connected to the interior of the fillable container. In this system, the temperature sensor is coupled to the vapor compression cycle refrigeration system.

An additional embodiment of the invention is a method of infusing a liquid with a flavoring or taste modifying material. This method comprises infusing a liquid in a container with infusible material, wherein the container is pressurized with a gas and the liquid therein is provided at a dispensing temperature; and dispensing the liquid from the container at the dispensing temperature while maintaining gas pressure in the container during dispensing. In this method, the gas pressure is maintained by introducing additional gas into the container as infused liquid is dispensed, and by sensing the pressure in the container with venting of headspace as if the desired pressure is exceeded.

The dispensing temperature is preferably a temperature below ambient and the method further comprises cooling the liquid to the dispensing temperature while the liquid is infused with the infusible element. The liquid may be cooled by accommodating ice formation on the heat exchanger while allowing the liquid to flow nearby and by sensing temperature of the liquid to be dispensed to provide cooling when the sensed temperature falls below a certain value. The method further comprises selectively directing a liquid from a source through a flow conduit to the fillable container, with the flow conduit also operatively associated with a liquid outlet to selectively allow dispensing of infused or source liquid through the liquid outlet.

The method also preferably comprises holding infusible material within the fillable container such that the liquid in the container contacts the infusible material in the cage prior to being dispensed through the liquid outlet, with the liquid or infusible material moved within the fillable container to facilitate contact and infusing of the liquid. Generally, the infused liquid would be filtered prior to dispensing to remove particulate material from the infused liquid.

Finally, either the liquid in the fillable container or the container itself, can be provided with various lighting features to impart visual effects thereto to assist in the marketing and commercial acceptance of the liquid.

### DESCRIPTION OF THE DRAWINGS

Preferred features of the invention will now be described in connection with the appended drawings, wherein:

FIG. 1 is an illustration of a front view of one embodiment of the invention.

FIG. 2 is a cross-sectional perspective view of the connection between the fillable container and the support portion the base.

FIG. 3 is a cross-sectional view of the top of the fillable container.

FIG. 4 is a cross-sectional side view of the top of the base and the bottom of the fillable container of the invention.

FIG. 5 is a view of the overall system of the present invention to illustrate the connection of the various components.

FIG. 6 is an illustration of a filter for use with the present invention.

FIG. 7 is an illustration of an LED lighting system for the fillable container or liquid contained therein.

FIG. 8 is a perspective bottom view of an ingredient cage for use in the present invention.

FIG. 9 is a top perspective view of the ingredient cage of FIG. 8.

FIG. 10 is an illustration of the capsule cage of FIG. 8 in position on the base of the device before placement of the finable container thereon.

### DETAILED DESCRIPTION

The present invention addresses the issue of temperature control and pouring pressure during the infusion process in an innovative way. Embodiments of the present invention prevent the liquid from rising above the foaming temperature throughout the infusion process by using a heat exchanger that is in thermal contact with the liquid during the infusion process. The heat exchanger pulls heat from the liquid, thereby maintaining the desired infusion temperature during the infusion process. The heat exchanger is also in thermal contact with a cooling system (for example, a vapor-compression cycle refrigeration system) that removes heat absorbed by the heat exchanger and transports it away from the liquid during infusion. Embodiments of the present invention also use gas to pressurize the inside of the infusion chamber, thereby facilitating the dispensing of the infused liquid at pressure.

Embodiments of the invention are particularly well suited for infusing and flavoring beer, but they can be used with other liquids, such as wine, cider, hard liquor, soft drinks, iced tea, and water, among other things. A wide variety of infusing materials can be used, and they can encompass such diverse things as a plant (such as mint), a flower (such as hops), a fruit (such as an orange, banana, cherry, blueberry, raspberry, or cranberry), a vegetable (such as a pepper or pumpkin), a bean (such as a vanilla or coffee), a nut or legume (such as a pistachio or peanut), a seed (such as cardamom), a wood (such as oak or oak soaked in a distilled spirit), a spice (such as cinnamon or pepper), an herb (such as lavender or rosemary), a root (such as ginger), an extract, a syrup (such as maple syrup), chocolate, candy, or any other type of flavoring item (such as an oil, resin, gel, or powder). Most typically, infusion imparts a new or enhanced flavor to the liquid, although the infusion could be done for other purposes, such as for imparting vitamins, boosters, or remedies for medicinal or health-related reasons to the liquid. These infusing materials can come not only in the natural form of the material, but also in different forms, such as powders, liquids, solids, pastes, or particulates. The prior list and categories are merely illustrative of the many type of infusing materials that can be used with an infuser, and are not meant to be an exhaustive list of all possible infusing materials.

The figures illustrate a preferred embodiment of the invention, but it is only one of many possible embodiments. In particular, this invention can be incorporated into the systems and devices disclosed in U.S. non-provisional patent application Ser. Nos. 14/149,136 and 14/258,061, such that the entire content of each prior application is expressly incorporated herein for a further disclosure the certain features of those systems and devices for use with the present invention.

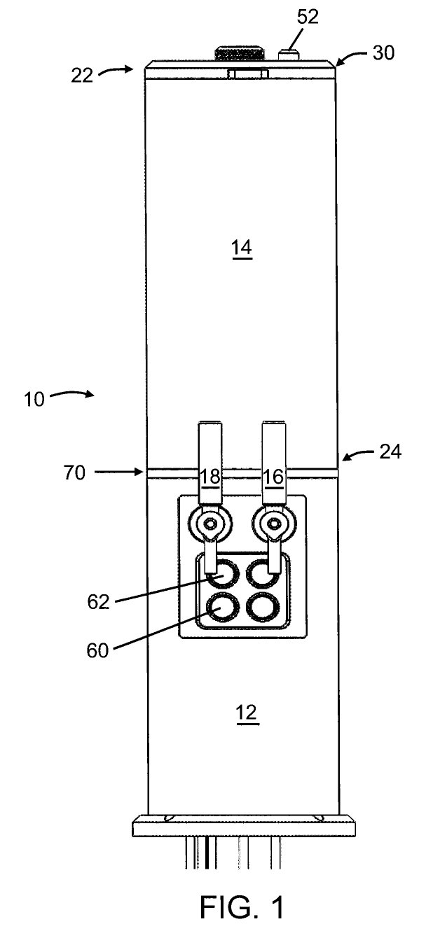

As can be seen in FIG. 1, one embodiment of the invention (infuser 10) is comprised of base unit 12 on which fillable container 14 rests. Base 12 is a 12″ tall cylinder with an outer diameter of 6″, and is made from 1/16″ stainless steel, but other materials (such as aluminum, plastic, copper, etc.), shapes (such as having a rectangular, hexagonal, octagonal, non-uniform, decorative, or abstract cross-section or shape, etc.), and sizes (shorter, taller, narrower, or wider) could be used and still fall within the scope of the invention. Base 12 acts as an outer shell to contain the various components that are discussed below, as well as acting to support infuser 10 wherever it is mounted. Base 12 can be placed or mounted directly on a surface where the user intends to dispense liquids infused in infuser 10, such as behind or upon a bar counter or table. Base 12 is further comprised of two faucets/handles 16 and 18 from which a liquid (such as beer, wine, water, soda, juice, etc.) can be dispensed.

While there are two dispensing faucets 16 and 18 in base 12, the invention can work with only one faucet or more than two faucets. In the present embodiment, faucet 16 is a standard beer faucet that is in fluid communication with the interior chamber 20 of fillable container 14. Faucet 18 is also a standard beer faucet in fluid communication with another liquid source, such as a beer keg, water line, soda line, etc., that is not in fluid communication with fillable container 14. The fluid contents of interior chamber 20 can be dispensed by moving the handle laterally to operate faucet 16 in a conventional manner. While standard beer taps are used for faucets 16 and 18 in this embodiment, other types of dispensing faucets or control valves could be used, such as a solenoid valve, screw valves, soda/bar gun, etc.

Having the second faucet 18 is advantageous because it allows for the operator to dispense two different types of liquids from the same device, thereby saving space and providing additional convenience. In one example, faucet 16 could dispense infused beer, while faucet 18 dispenses an un-infused version of the same beer (for example, either by being connected to a different source of the same liquid or by being connected to a T-connector or other type of connection prior to the liquid entering valve 38 described below).

Fillable container 14 is comprised of a 0.125″-thick polycarbonate cylinder that is 6″ in diameter and 13.75″ tall. The total internal volume of fillable container 14 is approximately 150 fluid ounces but can vary depending upon the size and shape of container 14 based on the anticipated demand for dispensing of the infused liquid from chamber 20. The top and bottom ends 22 and 24 of fillable container 14 are open, although either or both could be partially or completely sealed and fall within the scope of the invention. Other materials and configurations of fillable container 14 could be used and fall within the scope of the invention. For example, fillable container 14 could be made from clear or colored glass or a clear or transparent colored plastic such as acrylic or polycarbonate or other kinds of plastic. Additionally, fillable container 14 can be made from an opaque material, such as stainless steel, or could be made in different thicknesses, among other things. In addition, fillable container 14 could be in other shapes and cross-sections, such as square, rectangular, triangular, hexagonal, octagonal, conical, pyramidal, or a non-uniform, decorative, or abstract shape (such as in the shape of a person, animal, plant, thing, etc.), among other things. Fillable container 14 could also be shorter or taller or narrower or wider and could hold more or less liquid as desired. Fillable container 14 holds sufficient quantities of infusing materials, such as those described above, based upon the amount of liquid to be infused and contained in chamber 20. The infusing materials are simply placed inside fillable container 14 before the top portion is sealed or through an access opening into a sealed fillable container 14 in order to infuse the liquid that enters fillable container 14.

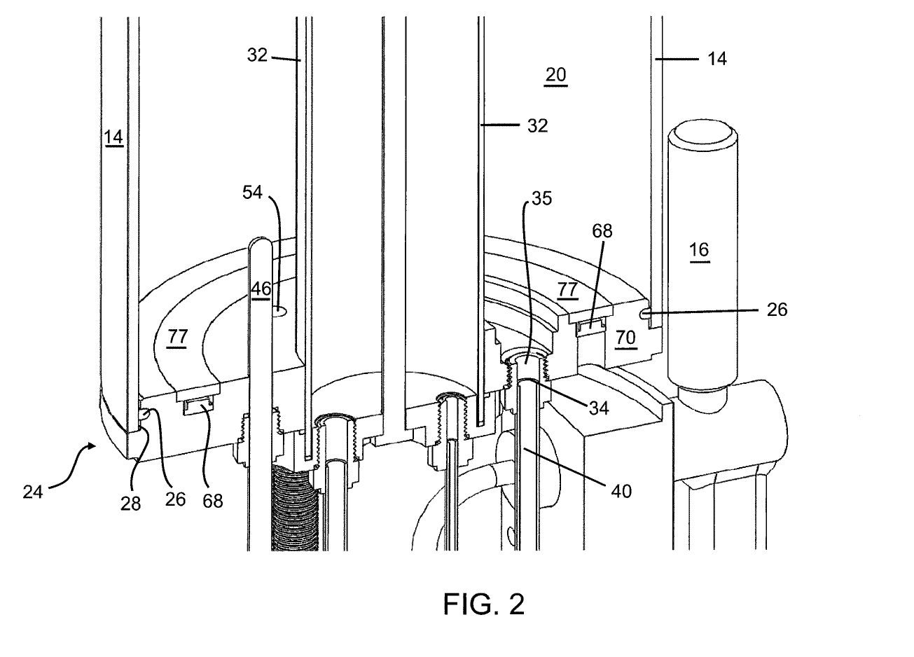

As shown in FIG. 2, fillable container 14 is sealed to topside 70 of base 12 via sealing O-ring gasket 26 between the inner, bottom side of fillable container 14 and a protruding portion 28 of base 12. In this configuration, the smooth surfaces of fillable container 14 and protruding portion 28 allow for a liquid-tight seal with O-ring 26 and prevent liquid in fillable container 14 from leaking out of bottom 24 of fillable container 14. Other mechanisms and configurations for sealing fillable container 14 to base 12 are possible, such as by having the bottom end 24 of fillable container 14 rest on a gasket in base 12 or by welding or adhering fillable container 14 to base 12, among other things.

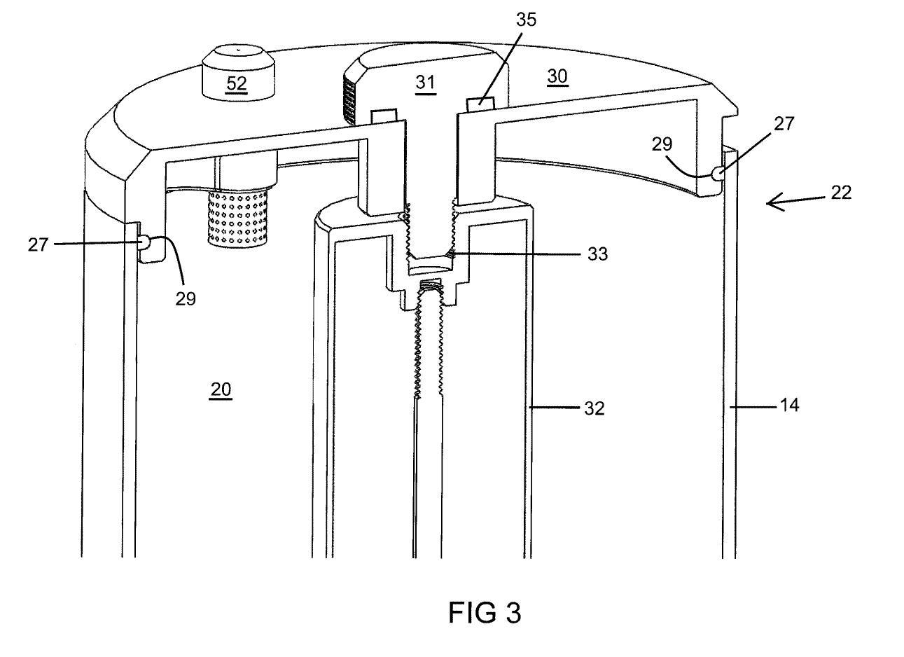

As shown in FIG. 3, fillable container 14 is sealed to top cap 30 in a similar fashion with another O-ring gasket 27 provided in channel 29. A threaded thumb screw 31 connects cap 30 to the top of heat exchanger 32 by threading into thread 33, thereby locking cap 30 in place and preventing it from becoming disconnected from the rest of infuser 10. By removing thumb screw 31, cap 30 and fillable container 14 of FIG. 2 can be removed from infuser 10 for cleaning purposes. Thumb screw gasket 35 creates a pressure seal between thumb screw 31 and cap 30, which prevents gas or liquid from leaking out of fillable container 14 during operation of the infuser 10.

Again, there are other mechanisms for sealing fillable container 14 to cap 30, such as by having cap 30 rest on a gasket placed on top of top 22 of fillable container, among other things. Alternatively, top 22 of fillable container 14 does not have to be open, but could be permanently sealed, such as by making fillable container in the shape of a cylindrical cup, rather than an open cylinder or by welding it to cap 30.

As access to the interior chamber 20 of fillable container 14 is a preferred embodiment, the fillable container will be provided with gasket 26 on the bottom or gasket 27 on the top or with both gaskets. This also allows fillable container 14 to be removed for cleaning or if damaged or broken to allow repair or replacement.

When the fillable container 14 is permanently sealed at the top 22 and bottom 24, an access opening, such as a partial lid, or other sealable opening mechanism, can be provided to allow infusible materials to be placed into the interior chamber 20 as well as to allow the introduction of cleaning fluids into chamber 20 when, for example, it is desired to change the infusible material from one type to another for infusing a different flavor or feature into the beverage.

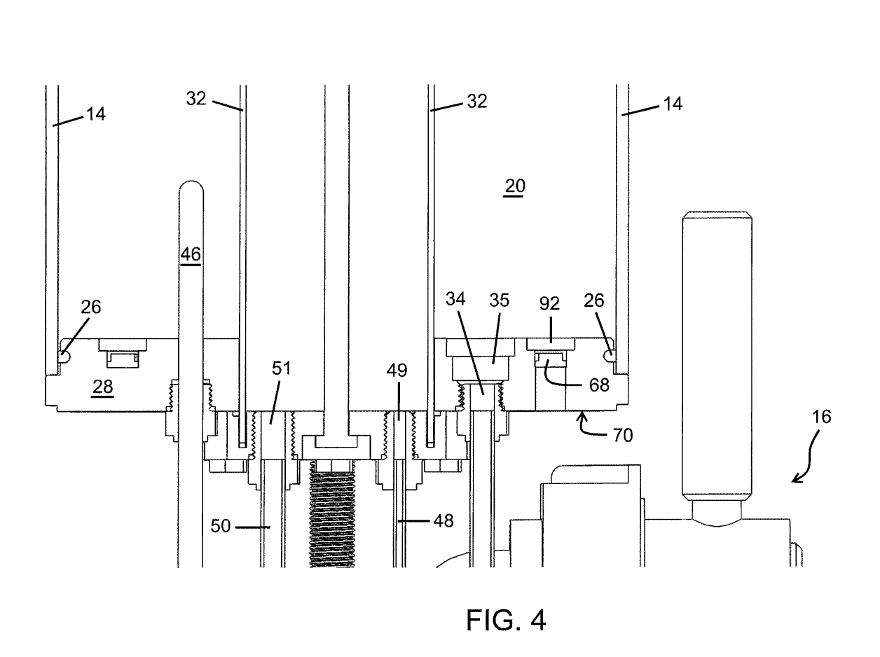

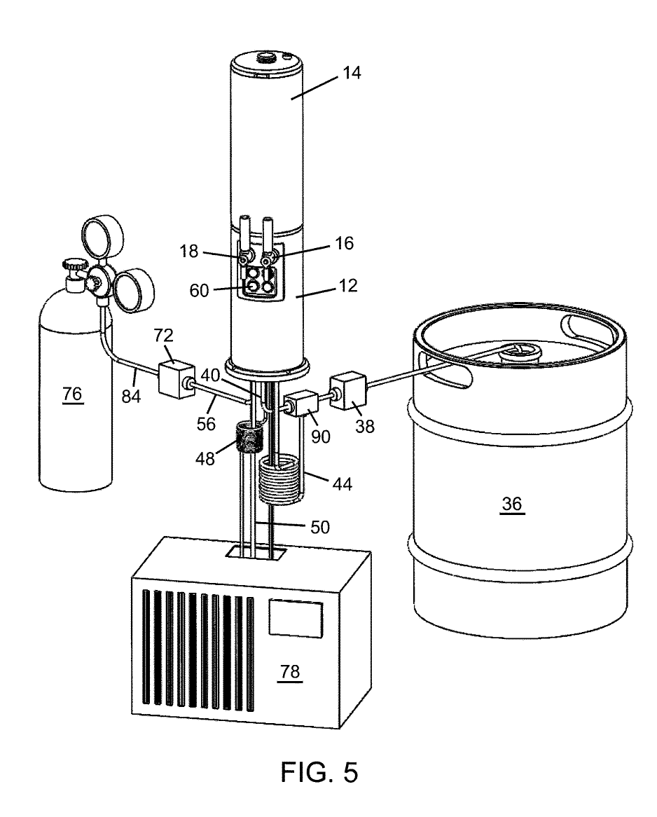

Inside fillable container 14 is heat exchanger 32 that extends through topside 70 of base 12 to the top of fillable container 14. As shown in FIGS. 2 to 4, heat exchanger 32 is preferably comprised of a 2″ diameter, 13.75″ high stainless steel cylinder with walls that are 1/16″ thick. As can be seen in FIG. 4, heat exchanger 32 couples to inlet and outlet lines 48 and 50, via inlet 49 and inlet 51 respectively, that pass through base 12. Inlet line 48 is a 96″ length of 0.0625″ inside diameter copper tubing and is coupled to heat exchanger 32 via a stainless steel bi-ferrule compression fitting with neoprene gaskets, which then is coupled to the remaining elements of cooling system 78, in this case, a vapor-compression cycle refrigeration system (e.g., a compressor, condenser, fans, etc.) as shown in FIG. 5. This cooling system 78 is then connected to outlet line 50 to form a closed-loop cooling system.

In this embodiment, heat exchanger 32 acts as the thermal expansion chamber. Refrigerant flowing through the 96″ of copper tubing experiences resistance. When the compressed refrigerant enters heat exchanger 32 through inlet 49 it rapidly expands thereby cooling, which chills the walls of heat exchanger 32 and, therefore, the liquid in interior chamber 20 of fillable container 14. In another embodiment, the 96″ of copper tubing could be replaced by an expansion valve to create the same expansion of refrigerant and cooling in chamber 20.

While the preferred cooling system 78 uses a r134a refrigerant, other refrigerants, such as chlorofluorocarbons, hydrofluorocarbons, hydrochlorofluorocarbons, perfluorocarbons, perchlorocarbons, hydrocarbons, halons, carbon dioxide, or ammonia, among other things, could also be used.

While the present embodiment specifies a vapor compression refrigeration system coupled to heat exchanger 32, wherein heat exchanger 32 behaves as the evaporator of a vapor compression system, other mechanisms are possible to evaporate a liquid within heat exchanger 32. For instance, instead of a vapor-compression refrigeration system, a tank of liquid CO2, such as a tank used to dispense draft beer, could be used. The tank could be inverted so when it is opened, liquid CO2 is released into heat exchanger 32, which would behave as an evaporator. These tanks have a fixed volume of liquid and will eventually become depleted, however they provide a cost effective alternative approach to a conventional vapor-compression refrigeration system. For instance, a 20-pound tank of CO2 used for dispensing draft beer could be coupled with a valve, such as a solenoid, to control the evacuation of the liquid CO2 from the tank when the tank is inverted and opened. A temperature sensor within the device (for instance inside chamber 20 or mounted upon inner wall of fillable container 14) can be coupled to the valve and cause it to open when the temperature inside fillable container 14 rises above a desired level. When the valve opens, liquid CO2 will rush from the 20-pound tank, through the valve and into heat exchanger 32 where the liquid CO2 will immediately boil and provide a cooling effect by absorbing heat. Other sources of compressed gas could be used, such as disposable cartridges of gas used for ISI creamers or pellet rifles.

The total internal volume of the heat exchanger/evaporator 32 is approximately 44 cubic inches, but smaller and larger volumes are possible with this design. In addition, the shape and configuration of heat exchanger 32 may vary and fall within the scope of the invention. For example, heat exchanger 32 could have a rectangular, square, hexagonal, octagonal, non-uniform, arbitrary, or decorative cross-section or shape, among other things. It could consist of multiple elements, which would increase the exposed surface area. It could also be made of different materials, such as copper, aluminum or other heat-conducting materials. These dimensions correspond to the particular geometry, materials, and coolant used for the described embodiment. If any of these parameters change, the useful size range of the evaporator will also change to encompass a region that is sufficient to cool the liquid.

Alternatively, heat exchanger 32 can be configured as one or more cooling tubes that are arranged in chamber 20 for cooling contact with the liquid therein. The cooling tubes can be configured and positioned therein to be arranged linearly vertically, in horizontal or vertical coils, or in horizontal or vertical spiral configurations, in combinations thereof or in any other configuration that ensures cooling contact with the liquid in chamber 20. These tubes can be made of metal, plastic or other materials that facilitate or at least do not hinder heat transfer. When the container 14 is made of a clear, transparent, or translucent material, the cooling tubes can include a color to provide a desirable visible appearance to the device.

In the described embodiment, heat exchanger 32 is cylindrical and is positioned concentrically within fillable container 14. This configuration is advantageous because it provides un-obstructed views of fillable container 14 from all sides. This enables improved visibility versus a configuration where the fillable container is not viewable from a side or from a particular angle. Visibility of infuser 10, specifically fillable container 14, is important because it increases the marketability of the contents of the infusion contained within fillable container 14. The addition of a single or multiple lights, such as LEDs, positioned within, on or around infuser 10 to illuminate the device, in particular the contents of fillable container 14, will also enhance visibility and overall marketability, with the evaporator also containing colors or configurations that can contribute further to the appearance of the device.

In the illustrated preferred embodiment, liquid within fillable container 14 is at maximum 1.875″ inches from heat exchanger 32. This proximity is intentional and advantageous because the closer the liquid is to heat exchanger 32, the more effectively it can be cooled. When the liquid is more than 2-4″ inches away from heat exchanger, the liquid will begin to develop warm spots because the heat must be conducted over a longer distance. Ideal configurations of the present invention should employ a heat exchanger and fillable container geometry so liquid within fillable container is close to the heat exchanger. The ideal distance is between 1 and 4 inches between the liquid and the heat exchanger. This distance accommodates ice formation on heat exchanger 32 while still providing room for liquid to flow without being too distant from heat exchanger 32.

Additionally, an auxiliary device that provides movement of the liquid in chamber 20 can be provided. A slow-moving stirring or agitating mechanism can be provided inside of chamber 20 and operated from the base of the unit. Alternatively and preferably, a circulating pump, such as a centrifugal or vibratory pump, could be incorporated in fluid communication with fillable container 14 to continuously or occasionally circulate the liquid contained within fillable container 14. This would help to homogenize the temperature and flavor of the liquid in fillable container 14 during the infusion process. A higher headspace pressure than described in the preferred embodiment may be required to mitigate foaming due to disturbances created by the circulating or liquid movement mechanism and/or the particular liquid that is present in chamber 20.

In one embodiment, tubing connected to lines 48 and 50 continues through the bottom of base 12 to the remainder of the vapor-compression cycle refrigeration system 78 (e.g., a compressor, condenser, fans, etc.) located elsewhere. This particular embodiment can be seen in FIG. 5. In another embodiment, the entire vapor-compression cycle refrigeration system 78 could be contained within base 12. In such a configuration, it is advantageous to provide venting in base 12 to the outside and insulation between cooling system 78 and the liquid being infused in fillable container 14 so as to reduce the heating of the liquid from the heat generated by cooling system 78 itself.

Also in topside 70 of base 12 is temperature sensor 46, which is in the form of a thermocouple that preferably extends approximately 1″ above the top of base 12 and 1″ from heat exchanger 32. This can be seen in FIG. 4, which is a partial cross-section side view of infuser 10. Temperature sensor 46 is coupled to cooling system 78 and monitors the temperature of the liquid in fillable container 14 so that cooling system 78 can properly control the temperature of the liquid in fillable container 14. It has been found that locating the temperature sensor near the bottom of fillable container 14 and not too close to heat exchanger 32 is advantageous. If temperature sensor 46 is located too high in fillable container 14, the liquid being dispensed may be at a lower temperature than desired. Similarly, if it is located too close to heat exchanger 32, temperature sensor 46 may be fooled by the cooling from heat exchanger 32, thereby resulting in the dispensing of the liquid at a higher temperature than desired.

In the present embodiment, temperature sensor 46 is intentionally located near the bottom of fillable container 14 because it must be able to read liquid temperature even if the infuser 10 is only filled with a small volume of liquid. If temperature sensor 46 is placed for example 3″ vertically from the bottom, approximately 30 fluid ounces of liquid would be required to exist in fillable container 14 before the liquid height was sufficient to contact the temperature sensor. The positioning of temperature sensor 46 at or near the bottom of fillable container 14 is ideal because it can still accurately read the liquid temperature inside fillable container 14 even if fillable container 14 is minimally filled. Other locations (near the top, in the middle, etc.), types of sensors (such as thermistors, infra-red sensors, resistance-temperature detectors, crystal sensors, etc.), or even multiple sensors can be used and fall within the scope of the invention, however.

While the present embodiment uses a vapor compression cycle refrigeration system, other cooling systems, such as liquid-cooling (e.g., glycol), solid cooling (e.g., dry ice, ice, or other cooling medium held in a canister), thermoelectric cooling systems, or quantum mechanical cooling systems among other things, could be used and fall within the scope of the invention. Non-exclusive examples of alternative cooling systems are described in

U.S. non-provisional patent application Ser. Nos. 14/149,136 and 14/258,061, which as noted are incorporated by reference herein. Similarly, other sizes, shapes, materials, and coolants could be used and fall within the scope of the invention.

In the present embodiment, cooling system 78 is designed to keep the liquid (a specific example of which is beer) cooled to around 38° F. But this temperature can be varied depending on the type of liquid being infused and the preferences of the operator by adjusting the settings of cooling system 78 and using temperature sensor 46 to provide feedback and monitoring. For example, vodka could be infused at 0-40° F., beer at 25-38° F., soda at 35-45° F., white wines at 40-55° F., water at 50-60° F., champagne at 45° F. and red wines at 50-70° F. While a particular embodiment of the present invention employs the use of a single temperature sensor, multiple temperature sensors could be placed on the device to enable temperature readings from different areas of the device. For instance, a first temperature sensor could be placed in the middle of fillable container 14 transmit the temperature of the infusion while a second temperature sensor could be placed proximal to the inlet/outlet of fillable container 14 to provide the temperature of the liquid that will comprise the next dispensed serving of liquid.

As shown in FIG. 5, the liquid to be infused enters fillable container 14 via a 0.19″ inside diameter stainless steel liquid inlet line 40 that is in fluid connection with the interior of fillable container 14. Liquid inlet line 40 is connected to tee splitter 90, which is in fluid communication with two-way, normally closed solenoid valve 38 and dispensing line 44.

Liquid source 36 can be a beer keg line, water line, or soda line, or beer can, among other things. As shown in FIGS. 4 and 5, when valve 38 is energized, the liquid is directed from liquid source 36 through valve 38, through tee-splitter 90 and to liquid inlet line 40 and then into chamber 20 through opening 35. Tee-splitter 90 in between valve 38 and liquid inlet line 40 is also in fluid communication with dispensing faucet 16 via dispensing line 44.

When dispensing faucet 16 is closed and valve 38 is energized (and consequently opened), liquid flows from liquid source 36, through valve 38, through tee-splitter 90 into liquid inlet line 40. When valve 38 is not energized (and consequently closed) liquid contained within fillable container 14 can be dispensed through dispensing faucet 16 by opening faucet 16. There are seven feet of 0.1875″ ID vinyl tubing (dispensing line 44) between tee-splitter 90 and faucet 16 to restrict the liquid flow to within the ideal dispensing range. Valve 38 is controlled via switch 60 on the outside of base 12. Alternatively, valve 38 could be controlled by other means, such as by a toggle, button, touchscreen, or computer such as a microcontroller or Arduino among other things.

When solenoid valve 38 is not energized (and consequently closed), liquid no longer flows from liquid source 36 to fillable container 14. Instead the liquid flows from fillable container 14, back through opening 35, liquid inlet 34 and liquid inlet line 40 into tee-splitter 90 before traveling through outlet line 44. Outlet line 44 can be connected to dispensing faucet 16 or to something else, such as a container to hold infused liquids or to another infuser or growler filler, among other things. To use the present invention in conjunction with a growler filler, restricting the flow of liquid by employing outlet line 44 may not be ideal, since higher pressure may be required in the inlet of growler fillers. In such a case, widening the inside diameter of outlet line 44 and/or shortening the length of outlet line 44 may be advantageous so liquid can leave the device at a higher pressure. In the embodiment described here, outlet line 44 is connected to dispensing faucet 16. Because dispensing faucet 16 is itself a valve, when valve 38 is not energized, the liquid can only travel as far as dispensing faucet 16 until faucet 16 is opened.

Opening 35, liquid inlet 34, liquid inlet line 40, and outlet line 44 can take a variety of forms, from food-safe plastic or metal tubing, such as stainless steel, to machined channels or other types of pipes or conveyances that allow liquid to move. The present embodiment takes advantage of compression fittings to mate many of these lines and inlets. Compression fittings are ideal for this purpose because they safely enable low, medium and high-pressure liquid and gas flow. Compression fittings are also employed to connect refrigeration lines 48 and 50 to the interior of heat exchanger 32. Refrigeration lines are most commonly supplied in copper because of its flexibility, thermal properties and also because it can be brazed and welded easily. However, heat exchanger 32 is preferably made from stainless steel. In the present embodiment, compression fittings are used to mate copper refrigeration lines 48 and 50 to the stainless steel heat exchanger 32. Without compression fittings, joining these two dissimilar metals by welding, epoxy, brazing or soldering would be very challenging. Welding, epoxy, brazing and soldering present long-term manufacturability issues because they are often time and labor intensive techniques, especially for joining dissimilar metals such as copper and stainless steel.

While this particular embodiment employs a two-way, normally closed solenoid valve, other types of valves and valve configurations could be used and fall within the scope of the invention. For example, two separate valves could be used—one to control the flow of liquid into fillable container 14 from liquid source 36 and one to control the flow of liquid out of fillable container 14 to dispensing faucet 16. A toggle switch or switches (or other types of controls, such as buttons, toggles, touchscreens, or a computer) could be connected to valves to control their operation. In yet another alternative, one valve could be faucet 16. Other types of valves could be used instead of a solenoid valve—for example, manual, motorized, or pneumatic valves, or spool valves, among other things.

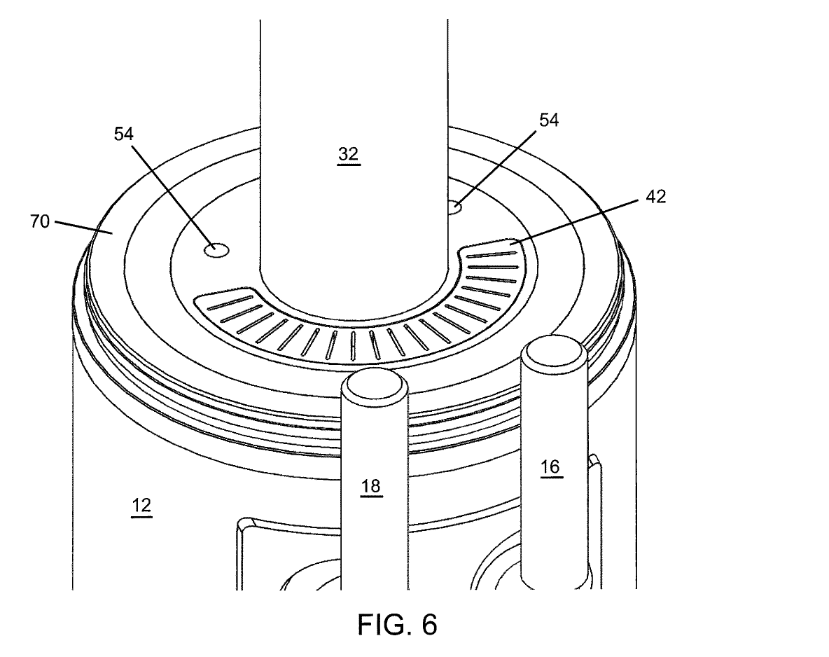

As shown in FIG. 6, a filter element that allows liquid from fillable container 14 but that removes particulate matter can be provided. Typically, this filter is a mesh filter 42 and is located at liquid inlet 34 between liquid inlet line 40 and fillable container 14 and in the top of base 12. Filter 42 helps to contain the bulk infusing materials in fillable container 14 and helps prevent them from exiting fillable container 14. The present embodiment uses a 60-mesh filtration screen, which is coarse enough to enable unrestricted flow but fine enough to filter out small particulates that would otherwise travel into liquid inlet line 40. If particulates travel to liquid inlet line 40, they may deposit into liquid valve 38, which may adversely affect its ability to properly open and close.

As shown in FIG. 3, a gas outlet in the form of vent relief valve 52 is located on cap 30. This spring-relief pressure release valve 52 is in fluid communication with the interior 20 of fillable container 14 and the outside air. In this embodiment, relief valve 52 is designed to open when the pressure inside fillable container 14 exceeds 20 pounds per square inch (psi) and will close again when the pressure drops to 18.4 psi. The psi values used throughout this detailed description are in psi gauge units (PSIG). Other types of pressure relief valves, such as diaphragm or weighted valves, or check (one-way) valves, among other things, could also be used.

In this embodiment, liquid coming from liquid source 36 is at a pressure of 24 psi when measured at liquid inlet 34. Liquid enters fillable container 14 as long as valve 38 is energized and faucet 16 is closed. When filling fillable container 14, the liquid will begin to increase the pressure in the head space above the liquid. Once the headspace pressure exceeds 20 psi, relief valve 52 will open and bleed out the excess gases until the flow of liquid into fillable container 14 is stopped, at which point vent relief valve 52 will continue venting head space pressure until the head space pressure is restored to 18.4 psi, in this case. In this embodiment, the liquid level in fillable container 14 is manually controlled via button 60 (FIGS. 1 and 5), however it could also be automated by using level sensors in fillable container 14 that would automatically disengage the power to valve 38 when the liquid reaches a specified height in fillable container 14. Without relief valve 52, the pressure inside fillable container 14 would increase until it reached the pressure of the incoming liquid (around 24 psi, in this case). At that time, the liquid would cease filling fillable container 14 due to the balance of pressures. This is not ideal because it only allows fillable container 14 to be partially filled, which leaves un-utilized space in fillable container 14.

In some instances, it may not be convenient or possible to achieve the desired pressure of liquid source 36 by increasing the pressure applied to liquid source 36 directly. For example, adding additional pressure to a beer keg may inappropriately carbonate or nitrogenize the beer contained within the keg. Instead of applying additional pressure to the liquid source, such as beer keg in this example, a secondary pump, such as a centrifugal pump, could be used in addition to mechanically propel the liquid from the liquid source 36 to the infuser 10. The pressure of liquid as it enters the device could be adjusted by increasing or decreasing the pressure of the pump rather than increasing or decreasing the pressure upon liquid source 36.

As shown in FIGS. 5 and 6, the gas inlet to fillable container 14 is gas inlet 54, which is located in the top side 70 of base 12, and it is connected to solenoid valve 72 and gas inlet line 56 inside base 12. Gas source line 84 connects gas valve 72 to a pressurized carbon dioxide (CO₂) gas source 76 external to infuser 10, such as a cylinder of compressed CO₂ gas, although other gas sources could be used depending on the type of gas and desired pressures. Typically, a gas source will be at a far higher pressure than desired for use in the infuser (e.g., at 800 to 6,000 psi). To overcome this pressure differential, the gas sources are often connected to a gas regulator, which reduces the output pressure from the gas source to the desired level.

In this embodiment, a check valve can be provided between gas inlet 54 and gas valve 72 to help to prevent any liquid in fillable container 14 from flowing backwards into the gas source. Alternatively, gas valve 72 could acts as a check valve, as well. A second gas inlet line 58 coupled to gas valve 72 can be optionally used to increase the amount of gas flowing into fillable container 14 even further. The flow of gas through gas inlet 54 is controlled via solenoid valve 72 that is in-line with gas inlet line 56. Other types of valves, such as those described above, could also be used. Solenoid valve 72 is controlled via switch 62 (FIG. 1) on the outside of base 12. Alternatively, gas line solenoid valve 72 could be controlled by other means, such as a toggle, button, touchscreen, or computer, among other things. While this embodiment positions gas inlet 54 near the bottom of fillable container 14 (on topside 70), other placements for gas inlet 54 are possible and fall within the scope of this invention. For instance, the gas inlet 54 could be positioned within fillable container 14 closer to the top, near cap 30, where it would rarely, if ever, encounter liquid interference from being submerged. The use of a sintered filter, or other filtration mechanisms such as mesh screens or breather vents, are advantageous when gas inlet 54 is positioned within fillable container 14 such that gas inlet 54 becomes submerged when fillable container 14 is partially or fully filled with liquid. One ideal placement of the filtration mechanism, such as a sintered filter or screen mesh, is in between gas inlet line 56 and gas inlet 54.

Inlet line 56, second inlet line 58, and source line 84 can take a variety of forms, from plastic or metal tubing, such as copper or stainless steel, to machined channels or other types of pipes or conveyances that allow gas to move.

When dispensing the liquid, the fluid connection from liquid source 36 to fillable container 14 is blocked by closing valve 38. Thus, without the gas pressurization system described herein, the liquid in fillable container 14 can only leave the infuser by expending the headspace pressure above itself to propel itself out of fillable container 14. The pressurized headspace contains a limited amount of gas and it will deplete quickly as liquid is dispensed. This will create inconsistent an flow of liquid out of dispensing faucet 16. Depressurizing the headspace gas will also cause the remaining liquid contents of fillable container 14 to degas (in the case of carbonated beverages, degassing means becoming foamy and flat). This is because the purpose of the headspace gas is to apply consistent pressure onto the liquid contained in fillable container 14, which will help to keep any dissolved gases within the liquid to remain dissolved. The gas pressurization system described herein helps to avoid the problem of headspace replenishment and allows fillable container 14 to be completely emptied if desired.

Gas outlet 52 and gas inlet 54 act in concert to create a situation where there is between 16-18.4 psi of carbon dioxide gas in the headspace above the liquid in fillable container 14 during dispensing. This pressure in the headspace helps to push the liquid out of infuser 10 when dispensing faucet 16 is opened. By energizing the gas-line solenoid valve 72 via button 62, a constant flow of carbon dioxide gas in enabled to maintain a sufficient headspace pressure for both pressurizing and dispensing the liquid contents of fillable container 14. Relief valve 52 acts to make sure that the headspace pressure can be controllably bled from interior 20 to permit partial or complete filling of fillable container 14, while at the same time restoring the pressure to 18.4 psi to ensure adequate pressure to propel the liquid out of fillable container 14. Alternatively, gas inlet 54 could be electrically or computer controlled to allow gas into fillable container 14 whenever the head space pressure dropped below a specified level.

During one possible operation of the device, fillable container 14 is pressurized with 16 PSI of compressed gas by opening gas valve 72. This gas will enter into fillable container 14 through gas inlet 54 via gas inlet line 56. This pressure is enough to sufficiently pressurize interior 20 but not enough to cause gas outlet 52 to open and begin venting, which only occurs when the pressure reaches and exceeds 20 PSI. Once fillable container 14 is pressurized, the flow of liquid from liquid source 36 into fillable container 14 is enabled. In one embodiment, shown in FIG. 5, flow between liquid source 36 and fillable container 14 is controlled via valve 38. When valve 38 opened, liquid flows from liquid source 36 into valve 38 where it passes through tee-splitter 90, which is connected to both liquid inlet line 40 and dispensing line 44. In this embodiment, dispensing faucet 16 is connected to the end of dispensing line 44. When the faucet 16 is closed, liquid cannot enter dispensing line 44 and must enter liquid inlet line 40 instead, where it ultimately enters fillable container 14 through liquid inlet 34 and opening 35. As long as valve 38 remains open and faucet 16 remains closed, liquid will continue to travel from liquid source 36 to the inside of fillable container 14. The liquid from liquid source 36 entering fillable container 14 will gradually pressurize interior 20 from 16 PSI to 20+ PSI, which will cause gas outlet 52 to open and begin venting headspace gas. The vented headspace gas provides room for entering liquid to take its place. Fillable container 14 will not fill if the pressure of incoming liquid at the liquid inlet 34 is less than the pressure fillable container 14 was initially pressurized to. For instance, if fillable container 14 was pressurized to 16 PSI but the pressure of liquid (measured at liquid inlet 34) is only 15 PSI, it will not flow into fillable container 14. The pressure of liquid as it enters fillable container 14 must be higher than the pressure fillable container 14 is initially pressurized to. In addition, the pressure of incoming liquid as it enters fillable container 14 must be higher than the opening threshold pressure of gas outlet 52 (if gas outlet 52 is a spring-return vent relief valve). For instance, if the incoming pressure of liquid as it enters fillable container 14 is 24 PSI (measured at liquid inlet 34) but gas outlet 52 opens at 30 PSI, the fillable container 14 will not fill completely because gas outlet 52 will not open to vent headspace pressure which is required to fill fillable container 14 entirely. A manually operated, pneumatically or computer operated venting valve could also be used instead of or in addition to a vent relief valve.

Once fillable container has been filled either fully or partially with liquid, valve 38 is closed thus preventing more liquid from flowing from liquid source 36 into fillable container 14. To dispense the contents of fillable container 14, dispensing faucet 16 is opened, which permits liquid to flow from fillable container 14, back through opening 35, liquid inlet 34, and liquid inlet line 40 and into tee-splitter 90. When valve 38 is closed, the only exit for the liquid is through tee-splitter 90, into dispensing line 44 and out of dispensing faucet 16.

To help maintain the desired temperature of the liquid, the inlet and outlet liquid lines can be cooled or otherwise maintained at the desired temperature. This could be achieved by placing cooling base 12 or otherwise associating cooling elements with these lines.

As liquid is dispensed from fillable container 14, the headspace pressure is maintained at 16 PSI from the incoming gas, which naturally flows into fillable container 14 through gas inlet 54 when the headspace pressure drops below 16 PSI. In this embodiment, a constant input of 16 PSI from gas inlet 54 enables a constant and ideal flow of liquid out of dispensing faucet 16. Without pressurized gas continuously entering fillable container 14 through gas inlet 54, the liquid within fillable container 14 can only propel itself out under the existing headspace gas, which is limited and will decrease as liquid is dispensed. This will consequently de-gas the remaining liquid contents of fillable container 14 as headspace pressure drops. Eventually the headspace pressure will reduce to the point where it can no longer propel the remaining liquid contained within fillable container 14 through dispensing line 44 and out of faucet 16. This is a tremendous disadvantage because it inevitably leaves un-dispensable liquid trapped within fillable container 14.

To completely dispense the contents of fillable container 14, dispensing faucet 16 is kept open so that all liquid contained within fillable container 14 is dispensed. Replenishing headspace gas will continue to enter through gas inlet 54, as long as gas valve 72 remains open. The flow of gas through gas inlet 54 is controlled by coupling a valve, such as a solenoid or ball valve (valve 72 in this embodiment), in fluid communication with gas inlet 54 to enable or disable the flow of gas through gas inlet 54. Closing valve 72 disables the flows of gas into fillable container 14. With gas no longer entering through gas inlet 54 and all liquid evacuated, the remaining pressurized gas inside fillable container 14 will exit out of dispensing faucet 16 and eventually the entire system will become depressurized. This enables access the interior 20 of fillable container 14 to replace, refresh, reposition or remove elements from fillable container 14.

This particular embodiment is advantageous because it permits fillable container 14 to be either fully or partially filled with liquid from liquid source 36. Whether fully or partially filled, this configuration permits the liquid contents of fillable container 14 to be dispensed under ideal pressure and flow conditions without leaving liquid trapped inside fillable container 14. From a commercial perspective, the present embodiment provides a high level of flexibility for dispensing in both high and low volume scenarios. For instance, the present embodiment is capable of readily filling, infusing and dispensing as many as 80 servings of beer in one hour while also being capable of discreetly filling, infusing and dispensing as little as 5 servings of beer over three hours.

The present embodiment is also particularly well suited for minimizing the amount of trapped liquid within fillable container 14 because of the intentional positioning of liquid inlet 34, which also acts to transport liquid out of fillable container 14. Liquid inlet 34 is positioned at the lowest point within fillable container 14 below opening 35, which enables all of the liquid to be evacuated. For instance, if liquid inlet 34 were positioned near the middle of fillable container 14, it would prevent any liquid below liquid inlet 34 from being recovered without adding additional liquid outlets. It is also advantageous to position liquid inlet 34 at the bottom of fillable container 14 because it allows the liquid to enter fillable container 14 from the bottom and gently fill upwards. For instance, if liquid inlet 34 were positioned near the top of fillable container 14, as liquid entered the interior 20, it would fall to the bottom of fillable container 14 and splash, which would degas the liquid (if the liquid of choice contained dissolved gasses, such as CO2 or N2). Positioning liquid inlet 34 at the bottom of fillable container addresses and solves these two major problems.

The specific pressures and limits described here have been optimized for the specific embodiment disclosed herein and are not meant to be the only pressures and limits that can be used with the invention. The invention can be used with different pressures and limits to accomplish the same functionality and purpose and may vary depending on a number of factors, including the physical setup and dimensions, the pressure of the liquid source being used, the desired output pressure of infuser 10, and the operator's preferences, among other things. For example, the liquid and gas sources could range in pressure from 1-100 psi. If, for example, the liquid source has a pressure lower than 24 psi, then the resulting relief valve parameters and pressurized gas source pressures will also have to be decreased. Similarly, if the operator desires to have the liquid dispensed at a higher pressure, than the relief valve parameters and carbon dioxide pressures will also have to be increased. These are only some of the reasons and variations that might require adjustment of the parameters described above, and the precise changes required will be depend on the precise changes made.

Using carbon dioxide as the headspace replenishing gas is advantageous for multiple reasons. First, it does not impart any additional, uncharacteristic tastes to the beer, because beer naturally contains dissolved carbon dioxide. Second, the process described here will actually act to slightly re-carbonate the beer being dispensed to compensate for any minor carbonation losses in infuser 10 or to impart carbonation to the liquid if it was not originally carbonated. While carbon dioxide has been found to be an effective gas to use, other gases could be used (such as nitrogen, CO₂/nitrogen blends, air, etc.) and fall within the scope of the invention.

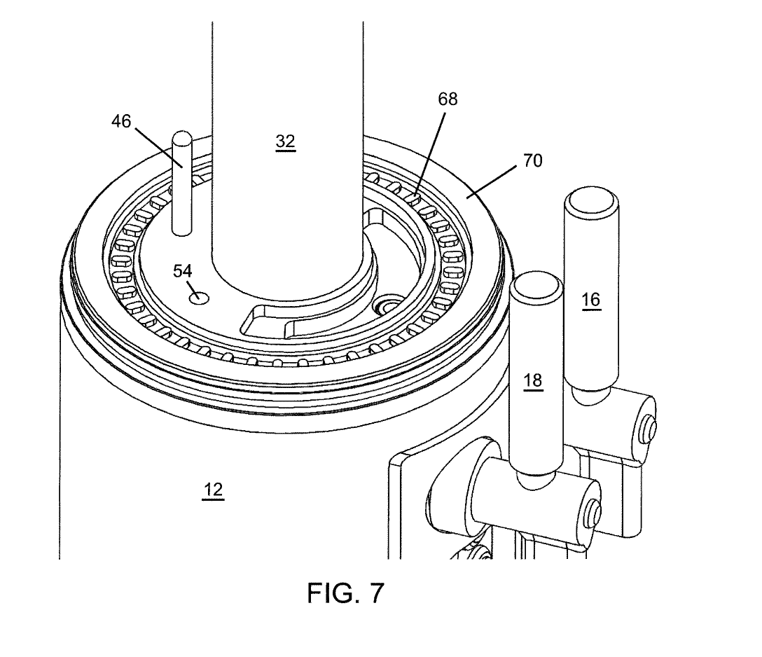

As shown in FIG. 7, in topside 70 of base 12, there is a circular ring of LED lights 68 that illuminates interior 20 of fillable container 14. Lights 68 provide a means for seeing the liquid contained within fillable container 14, as well as increasing the aesthetics of the experience. For example, the lights can provide coloring to the liquid while it is in the infuser in order to make the infused liquid more desirable to the customer. The lights can also act as a visual draw to the infuser and increase customer awareness of infused liquids. In this embodiment, the multiple LED lights are mounted inside fillable container 14 and protected under polycarbonate window 77 (FIG. 1). A preferred polycarbonate window 77 is optically clear and is used to allow the light to transmit therethrough as well as to protect the LED lights from becoming damaged by coming into contact with liquid contained within fillable container 14. Glass or other clear plastic materials can be used instead of polycarbonate depending upon the liquid. The LED lights can also be used to signal the operation of infuser 10 by being electrically coupled to one, some or all of faucets 16 and 18 and buttons 60 and 62 and by turning a different color when liquid is filling fillable container 14 or when liquid is being dispensed from infuser 10. Lights 68 could also be electrically coupled to temperature sensor 46 and used to indicate when the temperature of the liquid is at, above, or below a desired temperature setting or range. While the lights are located in a ring in base 12 in this embodiment, they could be located at different or multiple positions in and around infuser 10, such as in cap 30 or along heat exchanger 32. They can also take the form of individual lights, and not just ring lights. While pleasing to see, they are not required for the infuser to work. Lights 68 could be of a single or multiple colors and can be of a variety of types, such as LEDs, incandescent, or fluorescent, among other things.

As a general matter, it has been found that surfaces that are in contact with the liquid being infused can easily corrode when liquids such as beer or soda are used. It has also been found that stainless steel, glass, and plastic surfaces provide better resistance to corrosion for many liquids, so, where possible, the components that are in contact with the liquid in this embodiment are made from either stainless steel, glass, or plastic. The infuser can be made of other materials (such as copper, aluminum, plastic, stone, etc.) and fall within the scope of the invention, but care will need to be taken to keep the materials clean or to replace them if the corrosion becomes significant. For reasons related to primarily manufacturing costs, aluminum is a common replacement for stainless steel. If aluminum is used to construct the current invention, it should be anodized and/or coated with another sufficiently protective coating to protect against corrosion such as PTFE or other fluorocarbons or inert plastic materials.

During operation of the present embodiment of infuser 10, infuser 10 is connected to liquid source 36 (such as a beer keg) via liquid tubing connected to liquid inlet line 34. Infuser 10 is also connected to pressurized gas source 76 (such as a cylinder of CO₂ gas) via gas source line 84. Fillable container 14 is pressurized to 16 psi before the liquid enters fillable container 14 by engaging switch 62, which controls the flow of gas into fillable container 14 via gas valve 72. By pre-filling fillable container 14 with pressurized gas, it reduces the amount of foaming that occurs when a liquid, such as beer, enters an unpressurized container.

Next, switch 60, which controls the direction of flow through liquid valve 38, is engaged in order to fill fillable container 14 with liquid by opening liquid valve 38. As the liquid fills fillable container 14, the pressure of the gas above the liquid in the headspace increases because the volume available for it is reduced. Once the headspace gas pressure exceeds the threshold for pressure relief valve 52, pressure relief valve 52 opens and remains open until the headspace pressure has been restored to 18.4 PSI. In this manner, fillable container 14 can be filled with a liquid in a manner that reduces undesirable foaming of the liquid. Once the liquid reaches the desired level in fillable container 14, switch 60 is disengaged, which switches liquid valve 38 from the open to the closed position. The liquid will not immediately leave infuser 10, because faucet 16 remains closed.

As the liquid sits in fillable container 14 with some infusing material, the liquid becomes infused with the flavors or properties of the infusing material. When the operator desires to dispense the liquid, he or she opens faucet 16. As the liquid leaves fillable container 14, the volume of the space above the liquid in fillable container 14 increases, which causes the headspace pressure to decrease. In order to compensate for the loss in headspace pressure, additional pressurized gas will flow enter fillable container 14 when the headspace pressure inside fillable container 14 drops below 16 PSI.

While the present embodiment lends itself to being mechanically affixed to a table or bar top for example, substantially smaller, even hand-held and portable iterations of the invention are possible and fall within the scope of the invention. For instance, in one embodiment the volume of fillable container 14 is reduced to contain 20 fluid ounces instead of 150 fluid ounces. Furthermore, gas inlet 56 and liquid inlet 34 are employed as poppet valves so they can be reversibly attached to the liquid inlet line 40 and gas inlet line 56, which would also be employed with complementary poppet valves. In this configuration, the mechanisms that provide and control the flow of liquid and gas to and from the fillable container are reversibly attachable to fillable container 14. A back-pressure relief valve is also incorporated in liquid inlet line 40 to enable the poppet to move when the liquid inlet line is fully primed with liquid. This separation enables smaller, hand-held iterations of the device that also fall within the scope of this invention. There are many ways to refrigerate the infuser even when in a smaller configuration when a conventional vapor compression cycle system is no longer practical, due to its size. For example, heat exchanger 32, which is also made proportionally smaller along with fillable container, may be connected to a 12-gram disposable CO2 cartridge. When the 12-gram cartridge is punctured, the liquid within the cartridge will evacuate into heat exchanger 32, which acts to expand the liquid and consequently cool the device. Alternatively, the smaller infuser configuration could be submerged either partially or fully within an ice bath. Constructing the device from thermally conductive materials, such as copper, aluminum, stainless steel or titanium, would be advantageous for that reason. Furthermore, in a configuration wherein the fillable container is reversibly attachable from liquid inlet line 40 and gas inlet line 56, the fillable container itself can be placed into a normal refrigerator or freezer to lower the temperature. To dispense the contents of the fillable container in such an embodiment, a re-sealable opening is incorporated at or neat the top of the fillable container to allow the consumer to drink directly from fillable container, like a can, or pour the contents into another drinking container such as a pint glass.

In the present embodiment, a gas valve 72, a gas inlet 54, a gas outlet 52, a liquid inlet 34 and a liquid valve 38 are employed wherein the gas valve 72 is a two-way solenoid, liquid valve 38 is a two-way solenoid and gas outlet 52 is a spring-return vent relief valve with opening threshold pressure of “x psi” and a resealing (closing) pressure of “y psi”. As a general matter for determining the ideal gas inlet psi and liquid inlet psi for all x values below 100 psi, the following formulas are disclosed:

Gas inlet psi max=(y−0.5 psi)

Gas inlet psi min=(y−12 psi)

Liquid inlet psi max=(x+12 psi)

Liquid inlet psi min=(x+0.5 psi)

As a general matter, the present embodiment is very well suited for infusing beverages, such as beer, with ingredients by placing them together inside fillable container 14 and displaying the infusion in a marketable and commercially viable way. However, the described invention can also be used as a normal dispensing system, wherein the device is not used as an infuser and no ingredients are placed into fillable container 14. In this instance, the infuser 10 operates in the same way. There is substantial market value in merely displaying beer alone, or other previously flavored or unflavored beverages within fillable container 14. It enables the consumer to see the beverage and observe its physical properties, such as color and density, which may influence a purchasing decision when the device is used in a commercial setting such as a bar. In that regard, the device is equally effective at displaying, marketing, refrigerating and dispensing a beverage without infusing it.

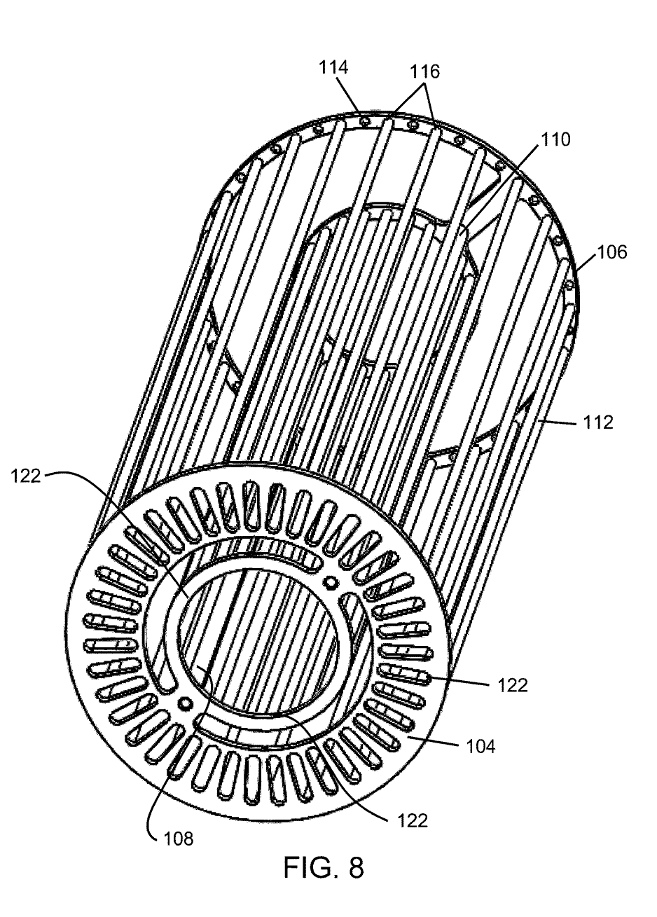

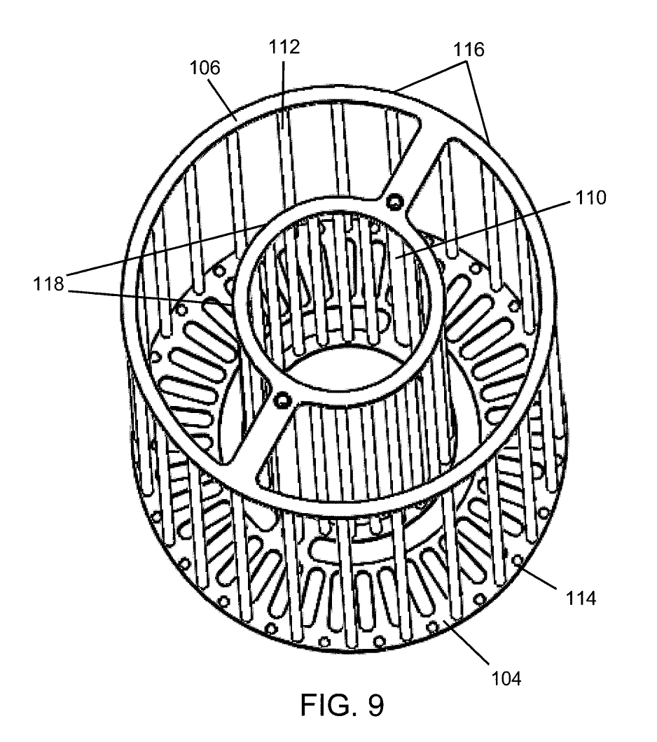

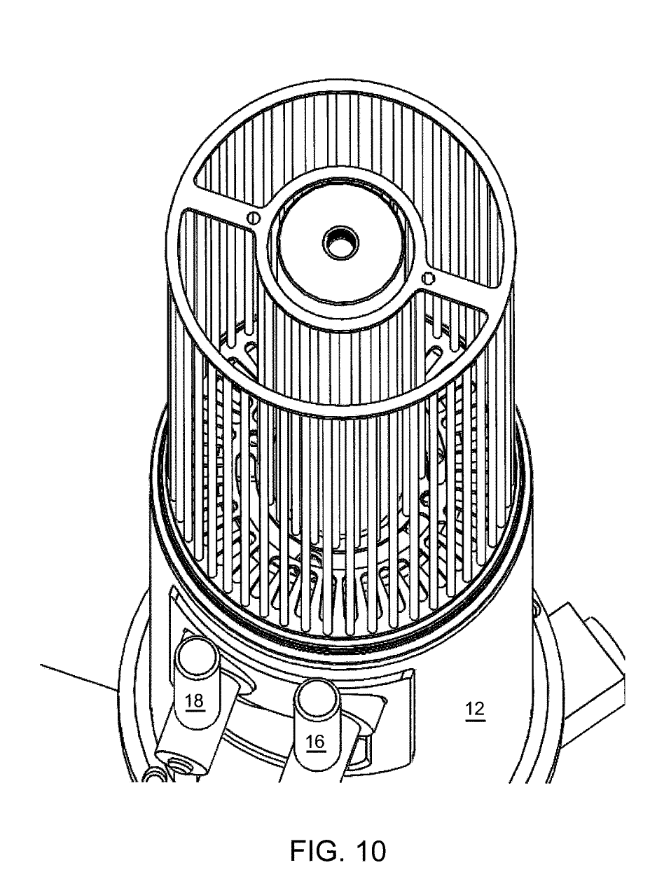

The present invention also makes use of an ingredient cage 150, which can be seen in FIGS. 8-10. The ingredient cage is designed to contain fine or coarse infusible materials, such as coffee beans or strawberries. It is constructed of top plate 106 and bottom plate 104, which when attached via cage bars 108 and 110, which hold cage rods 112 in place. Cage rods 112 are flexed into cage rod grooves 114, which are 3/32″ deep blind holes with diameter 0.260″. The present embodiment employs 48 cage rod grooves on the outer circumference 116, and 22 cage rod grooves on the inner circumference 118. In the present embodiments, inner circumference 118 is marginally larger than the diameter of heat exchanger 32 so heat exchanger 32 can pass through inner circumference 118 concentrically. This can be seen in FIG. 10. Cage rods 112, which are 0.125″ diameter cold-rolled stainless bars, can be flexed and inserted into cage rod grooves 114, at which point they straighten out again (once positioned in cage rod grooves 114) and become firmly, but temporarily affixed as part of the ingredient cage assembly 150. This allows the user to add or subtract cage rods from the assembly for the purpose of containing progressively finer or coarser ingredients. For instance, if the operator wishes to infuse orange wedges, which are relatively coarse, not all cage rods need to be inserted along outer circumference 116 to adequately contain the orange wedges. In another instance, the user may wish to infuse whole coffee beans, which are comparatively much finer. In that event, the user can insert all cage rods 112 along outer circumference 116 which will provide a more adequate geometry for containing smaller ingredients such as the coffee beans.

The design of cage assembly 150 is ideal and intentional. The more cage rods 112 that are included, the more those rods block visibility of the infusion. But by reducing the amount of cage rods to increase visibility also decreases the effectiveness of cage assembly 150 to contain the infusible ingredients. Therefore, there is a strategic balance between visibility and containment that must be achieved. Cage assembly 150 enables maximum visibility by allowing the user to insert the minimum number of cage rods 112 required to adequately contain a particular infusion. Cage assembly 150 acts to contain the bulk of infusible content while mesh filter 42 acts to filter out finer particulates. And to enhance the aesthetic appearance of the device, the cage rods can be provided with a colored or other decorative surface. Additionally, ingredient cage 150 could be constructed partially or entirely from transparent materials such as polycarbonate or acrylic, which would provide an even less obstructed view of the infusible elements contained within the infuser 10.

Also, when used with the LED lighting, shown in FIG. 7, the bottom plate 104 can include a number of openings 122 that do not block and instead allow the light from the LEDs to enter into chamber 20 to illuminate the liquid therein. Instead of these openings, cage 150 can be provided with a clear plastic bottom plate 104 for this purpose.

Alternatively, the infusible ingredients can be provided in a wire basket or other porous enclosure that can be admitted into the chamber 20 before the chamber is closed to receive liquid. When the fillable container is sealed, the porous infusible material enclosure can be placed into the chamber 20 through the access opening which of course would be sized accordingly to allow such entry. And instead of providing a pump or liquid stirrer or agitator, the basket can be mounted on a movement mechanism that rotates the basket or moves it along a path in the liquid to provide contact with the liquid and extraction of the infusible element into the liquid.

The foregoing descriptions have been presented for purposes of illustration and description, and are not intended to be exhaustive or to limit the invention to the precise form disclosed. The descriptions were selected to explain the principles of the invention and their practical application to enable others skilled in the art to utilize the invention in various embodiments and various modifications as are suited to the particular use contemplated. Although particular constructions of the present invention have been shown and described, other alternative constructions will be apparent to those skilled in the art and are within the intended scope of the present invention.

1. A system for infusing liquids, comprising:
a finable container with an interior chamber adapted to contain an infusing material and a liquid, the fillable container pressurized when containing a liquid therein; a liquid outlet in fluid communication with the interior chamber; a gas inlet in fluid communication with the interior of the tillable container; and a controller in operative association with the liquid outlet and gas inlet so that as liquid is dispensed from the liquid outlet, gas is introduced into the chamber by flowing through a gas valve.

2. The system of claim 1, further comprising a source of pressurized gas operatively associated with the gas inlet, with the controller allowing pressurized gas to pass through the gas valve into the container as infused liquid is dispensed to maintain pressure therein.

3. The system of claim 1, further comprising gas outlet or gas valve for the fillable container so that gas within the fillable container can be controllably bled out to enable liquid to enter the fillable container.

4. The system of claim 1, further comprising:
a heat exchanger in thermal contact with the interior of the tillable container; and
a cooling system in thermal contact with the heat exchanger to control the temperature of the liquid as it is being infused.

5. The system of claim 4, wherein finable container is configured and dimensioned to be sufficiently close to the heat exchanger to provide effectively cooling of the liquid in the container by accommodating ice formation on the heat exchanger while allowing the liquid to flow nearby.

6. The system of claim 4, wherein the heat exchanger is operatively associated with a cooling system that includes liquid coolant circulating within the interior of the heat exchanger.

7. (canceled)

8. The system of claim 1 further comprising a source of liquid, a first flow conduit that directed the liquid to the tillable container, a valve located on the flow conduit that when open allows liquid from the source to pass through the valve and conduit and into the fillable container.

9. (canceled)

10. The system of claim 1 further comprising a cage for containing infusible material, the cage configured and dimensions to reside within the fillable container and located in a position such that the liquid in the container contacts the infusible material in the cage prior to being dispensed through the liquid outlet.

11. The system of claim 1 further comprising a filter element located upstream of the liquid outlet to remove particulate material from the infused liquid.

12. The system of claim 1 further comprising lighting elements associated with the tillable container to impart visual effects to the container or to the liquid contained therein.

13. The system of claim 1 further comprising an auxiliary device that provides movement of the liquid or the infusible material in the finable container to promote contact infusing of the infusible material into the liquid.

14. A method of infusing a liquid with a flavoring or taste modifying material, which method comprises:
infusing a liquid in a container with infusible material, wherein the container is pressurized with a gas; and
dispensing the liquid from the container while maintaining gas pressure in the container during dispensing.

15. The method of claim 14, wherein the gas pressure is maintained by introducing additional gas into the container as infused liquid is dispensed.

16. The method of claim 14, wherein the liquid is provided at a dispensing temperature below ambient and which further comprises cooling the liquid and maintaining dispensing temperature while the liquid is infused with the infusible element.

17. to 19. (canceled)

20. The method of claim 14, which further comprises filtering the infused liquid prior to dispensing to remove particulate material from the infused liquid.

21. The method of claim 14 further comprising providing lighting to the liquid in the tillable container to impart visual effects thereto.

22. A method of filling a container containing infusible materials with a liquid, which comprises; pressurizing the container with a gas and then flowing liquid from a pressurized source into the fillable container while simultaneously bleeding out pressurized gas from the tillable container.

23. The method of claim 22 wherein the pressure differential between the source liquid container and finable container is between 0.01 and 50 PSIG when the source liquid is flowing into the fillable container, the pressure inside in the fillable container is being controllably bled out, and the flow of pressurized gas into the finable container has been disabled.

24. The method of claim 22 wherein the pressurized liquid source is a beer keg, the liquid is beer and the gas is carbon dioxide, nitrogen, argon, or a combination thereof.

25. The method of claim 22 wherein the pressurized liquid source is a beer pump, the liquid is beer and the gas is carbon dioxide, nitrogen, argon, or a combination thereof.
